(19) United States
(12) Patent Application Publication
(10) Pub. No.: US 2024/0135636 A1
(43) Pub. Date: Apr. 25, 2024

(54) IMAGE PROCESSING DEVICE, PRINTING SYSTEM, AND NON-TRANSITORY COMPUTER-READABLE STORAGE MEDIUM

(71) Applicant: SEIKO EPSON CORPORATION, Tokyo (JP)

(72) Inventors: Takuya ONO, Shiojiri (JP); Takahiro KAMADA, Matsumoto (JP); Mitsuhiro YAMASHITA, Matsumoto (JP); Yuko YAMAMOTO, Shiojiri (JP)

(21) Appl. No.: 18/489,050

(22) Filed: Oct. 17, 2023

(30) Foreign Application Priority Data
Oct. 19, 2022 (JP) 2022-168004

(51) Int. Cl. G06T 15/50; G06F 3/12; G06F 3/14; G06T 15/80; G06V 10/141; G06V 10/56; H04N 1/60

(52) U.S. Cl. CPC G06T 15/506; G06F 3/12; G06F 3/14; G06T 15/80; G06V 10/141; G06V 10/56; H04N 1/6016

(57) ABSTRACT

Image data expressed in a first color space is converted into an expression in a second color space to be used during rendering by using a color conversion profile, and converted image data is generated. A setting related to an application to physically-based rendering is performed on a parameter to be used when performing physically-based rendering on a print medium as a 3D object and related to an appearance of the print medium, the physically-based rendering of a printed print medium on which an input image is printed is performed using the set parameter, and a rendering image corresponding to an appearance of the print medium in a virtual space is displayed in a mode in which a difference in applications of the parameter during rendering is comparable.

The present application is based on, and claims priority from JP Application Serial Number 2022-168004, filed Oct. 20, 2022, the disclosure of which is hereby incorporated by reference herein in its entirety.

### BACKGROUND

### 1. Technical Field

The present disclosure relates to an image processing technique capable of displaying how a print medium appears.

### 2. Related Art

In the related art, preview of print medium is displayed prior to printing with a printer or a printing press. In order to make the preview of the print medium close to an actual appearance of the print medium, it is necessary to improve reproducibility of the print medium in consideration of various conditions such as a color tone of a light source. For example, JP-A-2018-74339 below discloses an example in which correction of a monitor, a printer, and illumination is switched on/off, and previews with these conditions being switched are displayed side by side or displayed by switching.

However, in the technique of JP-A-2018-74339, the correction of the monitor can be turned on and off, whereas it may be difficult to understand which color is correctly displayed. What is taken into consideration with respect to an appearance is a degree of correcting a color temperature of a display device according to a color tone of a medium, which is insufficient to reproduce an actual appearance of a printed matter. Therefore, for example, it is not possible to meet a demand for a designer to check a state of the printed matter prior to printing.

### SUMMARY

The present disclosure can be implemented in the following aspects.

(1) A first aspect of the disclosure is an image processing device that generates a rendering image of a print medium on which an image is printed. The image processing device includes: an image data acquisition unit configured to acquire image data which is data of an input image expressed in a first color space; a color conversion unit configured to perform color conversion of converting, using a color conversion profile prepared in advance, the image data into an expression in a second color space to be used during rendering, and to generate converted image data; an application setting unit configured to perform a setting related to an application to physically-based rendering on at least one parameter related to an appearance of the print medium among parameters to be used when performing the physically-based rendering on the print medium as a three-dimensional (hereinafter, referred to as 3D) object; a rendering execution unit configured to perform the physically-based rendering of a printed print medium on which the input image is printed using the converted image data and the parameter set for the application, and to generate a rendering image corresponding to an appearance of the print medium on which the converted image data is printed in a virtual space; and a display unit configured to display the rendering image in a mode in which a difference in applications of the parameters is comparable.

(2) A second aspect of the disclosure is a non-transitory computer-readable storage medium storing an image processing program of generating a rendering image of a print medium on which an image is printed. A non-transitory computer-readable storage medium storing an image processing program, the image processing program causing a computer to execute: a first function of acquiring image data which is data of an input image expressed in a first color space; a second function of performing color conversion of converting, using a color conversion profile prepared in advance, the image data into an expression in a second color space to be used during rendering, and generating converted image data; a third function of performing a setting related to an application to physically-based rendering on at least one parameter among parameters to be used when performing the physically-based rendering on the print medium as a 3D object; a fourth function of performing the physically-based rendering of a printed print medium on which the input image is printed using the converted image data and the parameter set for the application, and generating a rendering image corresponding to an appearance of the print medium on which the converted image data is printed in a virtual space; and a fifth function of displaying the rendering image in a mode in which a difference in applications of the parameters is comparable.

### BRIEF DESCRIPTION OF THE DRAWINGS

FIG. 1 is a schematic configuration diagram showing an image processing device according to an embodiment.

FIG. 2 is a flowchart showing an outline of color conversion processing.

FIG. 3 is a diagram illustrating a logical configuration of a rendering execution unit according to the embodiment.

FIG. 4 is a diagram schematically illustrating a display example of a print medium on which an image is printed.

FIG. 5 is a diagram illustrating a relationship between a light source and a viewpoint, and an angle of a surface of a 3D object.

FIG. 6 is a diagram schematically illustrating a state in which display of the print medium changes according to a change in an angle of a surface of the print medium on which the image is formed with respect to the light source.

FIG. 7 is a flowchart showing an image display processing routine.

FIG. 8A is a diagram illustrating an example of an internal configuration of the rendering execution unit.

FIG. 8B is a diagram illustrating an example of processing performed by a second pixel shader.

FIG. 8C is a diagram illustrating an example of processing performed by a first pixel shader.

FIG. 9 is a diagram illustrating an example of display for comparing processing results.

FIG. 10 is a diagram illustrating a difference in image display results depending on whether a texture parameter is applied.

FIG. 11 is a diagram illustrating another example of the display for comparing the processing results.

FIG. 12 is a diagram illustrating a state of selection of the texture parameter when a displayed image is changed or added.

FIG. 13 is a diagram illustrating another example of the display for comparing the processing results.

FIG. 14 is a flowchart showing an image display processing routine when a print profile and a texture parameter are set in a second embodiment.

FIG. 15 is a diagram illustrating a flow of processing including a case in which the print profile is used and a case in which the print profile is not used in the second embodiment.

FIG. 16A is a diagram illustrating details of main parts of the image display processing routine.

FIG. 16B is a diagram illustrating images obtained by a combination of switching on and off the print profile and switching on and off the texture parameter.

FIG. 17 is a diagram illustrating an example of a method of handling a plurality of images.

FIG. 18 is a schematic configuration diagram of a printing system according to a third embodiment.

FIG. 19 is a diagram illustrating an example of another print medium having an appearance of a print result.

### DESCRIPTION OF EMBODIMENTS

### A. First Embodiment

### A1 Hardware Configuration:

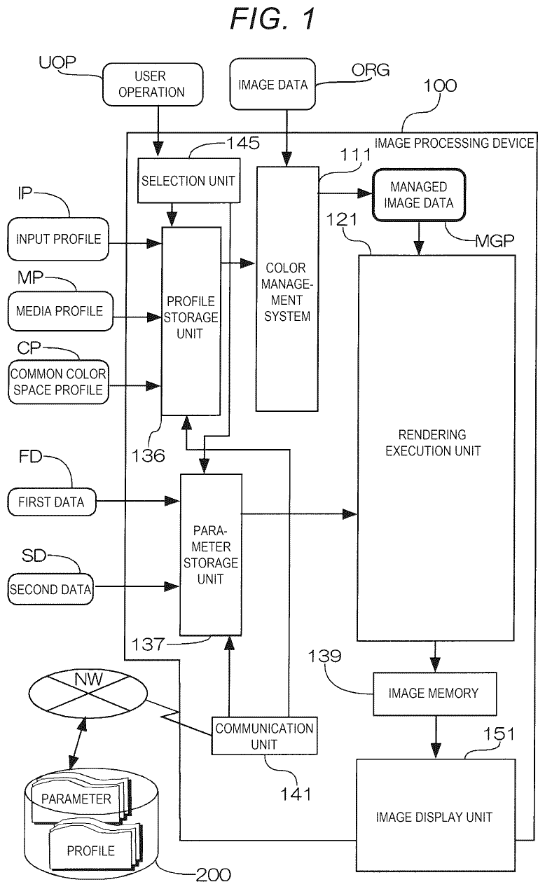

FIG. 1 shows a schematic configuration of an image processing device 100 according to an embodiment. The image processing device 100 performs image processing to preview a state in which an image is printed on a predetermined print medium. The image processing device 100 not only performs the image processing but also displays a processing result as a preview image. As shown in the drawing, the image processing device 100 includes a color management system 111 that mainly performs color conversion, a rendering execution unit 121 that executes rendering of a print medium, a profile storage unit 136 that stores various profiles used for the color conversion, a parameter storage unit 137 that stores various parameters used for rendering processing, an image memory 139 that stores an image that is an execution result of the rendering execution unit 121, a communication unit 141 that exchanges data with an external site 200 via a network NW such as the Internet, a selection unit 145 that receives a user operation UOP, and an image display unit 151 that displays a preview image. A program for performing each processing described later is stored in a memory (not shown) of the image processing device 100. Functions of the image processing device 100 are implemented by a CPU or a GPU executing the program stored in the memory.

The color management system may be hereinafter abbreviated as CMS for simplicity. The CMS 111 can acquire image data ORG representing an input image to be printed (hereinafter, referred to as an original image). The image data ORG may be obtained by wired or wireless communication from an image forming device that creates the image data ORG, or may be read from a memory card that stores the image data ORG in a file format. Of course, the image data ORG may be acquired via a network. Alternatively, the image data ORG may be created in the image processing device 100. When the image data ORG is created in the image processing device 100, the image data ORG may be output to an external printing device through communication or the like during printing.

The CMS 111 performs the color conversion on an original image to be a print preview into an object color expressed on the print medium. The converted image data is referred to as managed image data MGP. Details of processing by the CMS will be described later. The managed image data MGP is set as a texture of the print medium which is a 3D object. An input profile IP, a media profile MP, a common color space profile CP, and the like are input to the CMS 111 via the profile storage unit 136. The profile storage unit 136 corresponds to a color conversion profile unit that performs one of an acquisition and a setting of a color conversion profile used for the color conversion of the image. The input profile IP is used to convert from a device-dependent input-side color system such as RGB data to a device-independent color system such as L*a*b*, (hereinafter, simply abbreviated as Lab). The media profile MP is a profile representing color reproducibility at the time of printing on a specific print medium by a specific printing device such as a printer under printing conditions such as a specific printing resolution, and is a profile for converting a color value between a device-independent color system and a device-dependent color system. The media profile MP also includes information such as print settings of the printing device other than the print medium. For this reason, when all combinations of the printing device (the printer)×the print medium×the print setting are covered, the number of types of media profiles MP is increased, and therefore, when dependence of the printing condition is small, or when it is not desired to increase the number of profiles, the media profile MP is implemented as a combination of the printing device (the printer)×the print medium.

Since a color of an image on the print medium (a medium) is related to characteristics of the printing device and characteristics of the print medium itself, the media profile MP may be hereinafter referred to as the print profile MP. Among the print profiles MP stored in the profile storage unit 136, the setting to use any of the print profiles MP or not to use the print profile MP in the CMS 111 is performed by the user operation UOP via the selection unit 145. As described above, the number of the print profiles MP may be the number of printing device×print medium, and thus a print profile having a high frequency of use may be stored in the profile storage unit 136, selected as necessary, and referred to by the CMS 111. The print profile that is not normally used, such as the print profile MP having a low frequency of use, may be stored in the external site 200, and may be acquired via the communication unit 141 when necessary.

When the input profile IP is applied to the image data ORG and the print profile MP is further applied, a color value in the case of printing under specific printing conditions, that is, depending on the printing device or the print medium is obtained. When the print profile MP is applied to the color value of the image to be converted from the device-dependent color system to the device-independent color system, and the common color space profile CP is applied, the color value is converted to an expression in a second color space (here, a sRGB color space) used for rendering. Since the image data ORG is once converted into a color value depending on the characteristics of the printing device, the print medium, or the like using the print profile MP, the image data ORG is color-converted into a range of color values that can be actually printed. The common color space profile CP is used to convert the image data into a color value of a color space to be used during rendering. As a common color space, the sRGB color space is representative, and AdobeRGB, Display-P3, and the like may also be used.

As described above, the CMS 111 uses each profile to convert the image data ORG expressed in a first color space, which is the device-dependent color system, into the image data (the managed image data) MGP expressed in the sRGB color space, which is the second color space to be used during rendering. Here, the converted image data is not limited to the color value in the sRGB color space, and may be expressed in any color space as long as the image data is expressed in a color space that can be handled by the rendering execution unit 121. For example, when the rendering execution unit 121 employs a configuration that enables rendering using a color value, a spectral reflectance, and the like in the Lab or an XYZ color space, the image data may be converted into a color value used for display on the image display unit 151 in lighting processing (to be described later) performed in the rendering execution unit 121 or in a post-processing unit (to be described later) provided after the rendering execution unit 121.

The profile storage unit 136 acquires and stores the input profile IP, the media profile MP, the common color space profile CP, and the like. The parameter storage unit 137 acquires and stores first data FD and second data SD. The first data FD and the second data SD are parameters necessary for performing physically-based rendering and displaying the print medium as a 3D object on which the image is printed. In particular, the first data FD is data related to a form under a light source in a virtual space of the print medium, and includes 3D object information of the print medium, camera information such as a position at which the print medium is viewed, illumination information such as a position and a color of illumination, and background information indicating information of a background in which the print medium is placed. The second data SD is data related to image formation on a surface of the print medium, and includes, for example, data representing a texture of the surface of the print medium. The first data FD and the second data SD are stored in the parameter storage unit 137 and used during rendering performed by the rendering execution unit 121.

As for the first data FD and the second data SD, representative data whose frequency of use is equal to or higher than a predetermined frequency may be stored in the parameter storage unit 137 in a nonvolatile manner, selected as necessary, and referred to by the rendering execution unit 121. As the print medium, a material that is not normally used, such as a material having a low frequency of use, for example, texture data in a case in which a special material such as fabric, a can, or a plastic sheet is used may be stored in the external site 200, and may be acquired via the communication unit 141 when necessary. The first data FD such as the illumination information may be individually designated by a user during rendering, and a representative camera angle and a light source may be stored in advance in the parameter storage unit 137 and used. The camera angle is a position and a direction of viewing a target print medium, and corresponds to a virtual position of a viewpoint and a direction of a line-of-sight of the user viewing the virtual space. Therefore, the camera may be referred to as a “viewpoint” or a “view”, assuming that the camera is the viewpoint or the direction of the line-of-sight.

The image display unit 151 displays the image on the print medium rendered by the rendering execution unit 121 and stored in the image memory 139 together with a background and the like. The image display unit 151 reads image data for display from the image memory 139 provided in the rendering execution unit 121 and performs display. The image display unit 151 may be provided in the image processing device 100 or may be provided separately from the image processing device 100. The image processing device 100 may be implemented as a dedicated machine, or may be implemented by causing a computer to execute an application program. Of course, the computer includes a terminal such as a tablet or a mobile phone. Since considerable resources and calculation capability are required for the processing of the rendering execution unit 121, only the rendering execution unit 121 may be executed by a CPU capable of high-speed processing or a dedicated GPU, the rendering execution unit 121 may be implemented by dedicated hardware, or the image processing device 100 may be implemented in another site on the network.

### A2 Color Conversion Processing:

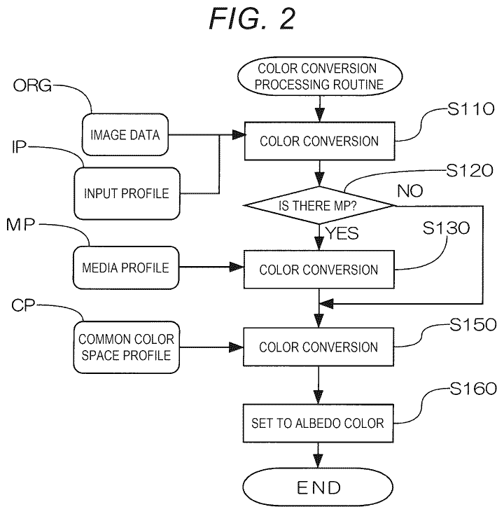

The color conversion processing performed by the CMS 111 will be described with reference to FIG. 2. FIG. 2 is a flowchart showing the processing performed by the CMS 111 in which the original image data ORG is converted into color data of a common color space for performing rendering processing. When the color conversion processing is started, first, the original image data ORG and the input profile IP are input, and processing of converting the original image data ORG represented by a device-dependent color system (for example, an RGB color system) into color data of a device-independent color system (for example, the Lab or the XYZ color system) is performed (step S110). Next, it is determined whether the media profile MP is prepared (step S120). When there is the media profile MP, the media profile MP is applied, and color conversion into a range of colors that can be expressed by printing is performed in consideration of a combination of the printing device (the printer)×the print medium (step S130) as the printing condition. When there is no media profile MP, the processing of step S130 is not performed. Thereafter, the common color space profile CP is used to convert the image data into a color value of the common color space, which is a second color space used during rendering (step S150). In the embodiment, the sRGB is used as the common color space. The managed image data MGP thus obtained is set to an albedo color, which is a texture of the 3D object (step S160), and the processing routine ends.

In step S130, when a rendering intent of the color conversion of the media profile is set to Absolute, a color (a ground color) of the print medium itself can be reflected. When the color value of the image to be color-converted in step S150 is outside a color gamut of a sRGB color space, the color value may be approximated to a value in the sRGB color space, or may be handled as a value outside the color gamut of the sRGB color space. RGB values of the image data are generally stored as 8-bit values of each color, that is, integers having values of 0 to 255. Instead of this, when pixel values are represented as floating decimal points having values of 0.0 to 1.0, the value outside the color gamut of the sRGB can be handled as a negative value or a value exceeding 1.0.

The color conversion executed by the CMS 111 is not limited to the configuration shown in FIG. 2, and may be performed by another configuration. For example, when correction data DPD is prepared for correcting deviation of a display color of the image display unit 151 with respect to the sRGB that is the common color space, the color conversion processing using the display device correction data DPD may be performed after the color conversion based on the media profile MP shown in FIG. 2 (step S130).

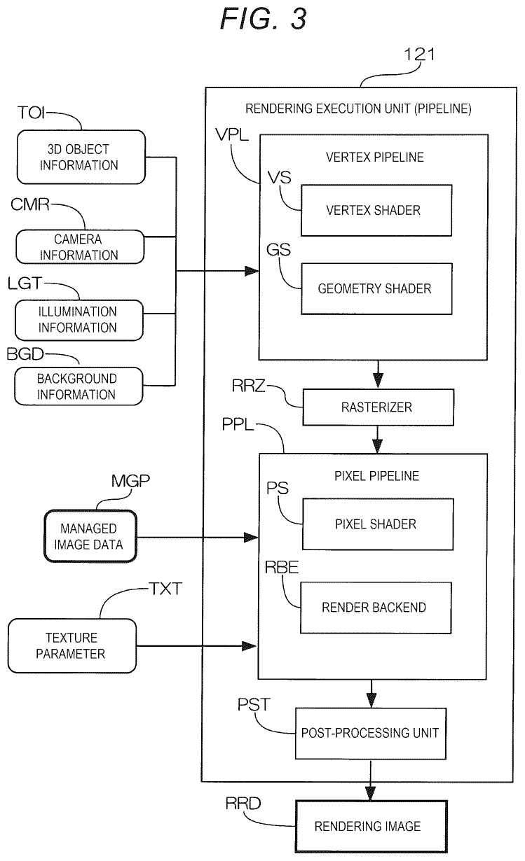

Combined correction data SPD obtained by combining such display device correction data DPD and the common color space profile CP in advance may be prepared, and the color conversion based on the combined correction data SPD may be performed instead of the color conversion based on the common color space profile CP (step S150). The correction for the deviation of the display color of the image display unit 151 may be performed by a post-processing unit PST after render backend shown in FIG. 3 to be described later, instead of being performed by the CMS 111.

### A3 Rendering Processing:

The rendering execution unit 121 renders a print medium which is a 3D object using an illumination model to be described later, reflects the managed image data MGP output by the CMS 111, and calculates how the print medium on which the original image data ORG is printed appears in the virtual space. The rendering execution unit 121 stores a result of the rendering processing in the image memory 139, and displays the result on the image display unit 151. A configuration example of the rendering execution unit 121 is shown in FIG. 3. The rendering execution unit 121 shows a representative configuration for performing physically-based rendering processing, and other configurations can be employed. The rendering execution unit 121 according to the embodiment employs a pipeline configuration including a vertex pipeline VPL and a pixel pipeline PPL, and executes the physically-based rendering at a high speed. The vertex pipeline VPL includes a vertex shader VS and a geometry shader GS. A configuration in which the geometry shader GS is not used is also possible.

The vertex shader VS converts coordinates on the print medium of vertices of the print medium, which is a 3D object, into coordinates in a three-dimensional space to be rendered. The coordinate conversion comprehensively includes coordinate conversion in the order of coordinates of a model to be rendered (here, the print medium)—world coordinates—view (camera) coordinates—clip coordinates, whereas conversion to the view coordinates and the like are performed by the geometry shader GS. In addition, the vertex shader VS performs shading processing, calculation of texture coordinates (UV), and the like. In the processing, the vertex shader VS and the geometry shader GS refer to the 3D object, camera information CMR, illumination information LGT, and background information BGD stored in a first storage unit 131.

3D object information TOI is information related to a shape of the print medium as the 3D object. An actual print medium is not a flat surface, and thus is basically handled as a collection of minute polygons. When the surface of the print medium is represented by the minute polygons, the number of polygons is enormous. Therefore, it is realistic to handle the surface of the print medium with textures such as a normal map and a height map. The normal map and the height map are given as texture parameters to be described later. The camera information CMR is virtual information indicating in which position and direction the camera is installed with respect to the print medium. The illumination information LGT includes at least one piece of virtual information such as a position, an angle, an intensity, and a color temperature of a light source in the virtual space in which the print medium is placed. A plurality of light sources may be set. In this case, influences of the plurality of light sources may be separately calculated and superimposed on the 3D object.

Although the background information BGD may be omitted, the background information BGD is information related to a background in which the print medium as the 3D object is placed in the virtual space. The background information BGD includes information on objects such as a wall, a floor, and furniture disposed in the virtual space, and the objects are rendered by the rendering execution unit 121 in the same manner as the print medium. In addition, since the illumination falls upon the background object to illuminate the print medium, the background information is also handled as a part of the illumination information. Rendering using such various kinds of information enables a stereoscopic preview. Vertex information calculated by the vertex shader VS is passed to the geometry shader GS.

The geometry shader GS is used to process a set of vertices in an object. By using the geometry shader GS, it is possible to increase or decrease the number of vertices at the time of execution or change a type of primitives forming the 3D object. An example of the increasing or decreasing the number of vertices is culling processing. In the culling processing, vertices that are not reflected by a camera are excluded from a processing target based on a position and a direction of the camera. The geometry shader GS also performs processing of generating a new primitive from an existing primitive such as a point, a line, and a triangle. The geometry shader GS receives a primitive having information of the entire primitive or an adjacent primitive from the vertex shader VS. The geometry shader GS processes the input primitive and outputs a rasterized primitive.

Output of the vertex pipeline VPL, specifically, the primitive processed by the geometry shader GS, is rasterized into data in units of pixels by a rasterizer RRZ, and is passed to the pixel pipeline PPL. In the embodiment, the pixel pipeline PPL includes a pixel shader PS and a render backend RBE.

The pixel shader PS operates the rasterized pixels and, in short, calculates the color of each pixel. Based on the information input from the vertex shader VS or the geometry shader GS, processing of synthesizing textures or processing of applying a surface color is performed. The pixel shader PS maps the managed image data MGP, which is obtained by converting the image data ORG by the CMS 111 based on various profiles, on the print medium as the 3D object. At this time, a lighting processing function provided in the pixel shader PS performs the lighting processing based on a reflection model of light of an object, the illumination information LGT as described above, and the texture parameter TXT which is one of the second data SD stored in a second storage unit 132, and maps the managed image data MGP. The reflection model used in the lighting processing is one of calculation expressions of a mathematical model for simulating an illumination phenomenon in the real world. The reflection model used in the embodiment will be described in detail later.

When the number of pixels after rasterization is large, such as when an output resolution is high, the processing of manipulating pixels is heavy and takes time. Therefore, compared to processing in units of vertices, the processing may take time and efficiency of pipeline processing may be insufficient. In the embodiment, by optimizing a processing program of the pixel shader PS for execution on a GPU having high parallel processing performance, a high-level effect including expression of texture is implemented in a short time.

Pixel information obtained by the processing of the pixel shader PS is further determined by the render backend RBE as to whether to be drawn in the image memory 139 for display. When it is determined that the render backend RBE may draw pixel data in the image memory 139, the pixel data is stored as being drawn. Tests used for determination of drawing include an “alpha test”, a “depth test”, a “stencil test”, and the like, which are known. The render backend RBE executes a set test among the tests and writes the pixel data to the image memory 139.

With the above processing, the pipeline processing of rendering is completed, and then processing for improving an appearance is performed on the data stored in the image memory 139 by the post-processing unit PST. Such processing includes, for example, anti-aliasing processing of smoothing an image by removing unnecessary edges in the image. In addition, there are processing such as ambient occlusion, screen space reflection, and depth of field, and the post-processing unit PST may be implemented to perform necessary post-processing.

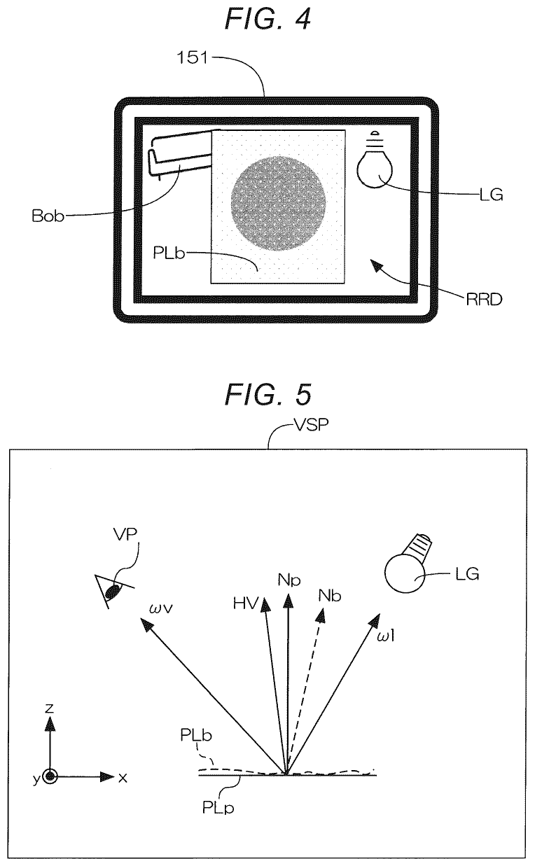

The rendering execution unit 121 performs the above processing to complete the rendering, and a result thereof is output as a rendering image RRD. Actually, the data written in the image memory 139 is read out in accordance with a display cycle of the image display unit 151 to be displayed as the rendering image RRD. An example of the rendering image RRD is shown in FIG. 4. In the example, the image display unit 151 displays a print medium PLb as a 3D object placed in the virtual space, a light source LG, and a background object Bob such as furniture existing as one of backgrounds.

FIG. 5 shows a relationship between the print medium PLb placed in the virtual space and the light source LG or a viewpoint (a camera) VP. The relationship between the light source LG or the viewpoint VP and the print medium PLb is three-dimensional in the virtual space VSP, whereas FIG. 5 shows the virtual space VSP in an x-z plane. x is a coordinate of collection points of vectors described below. A positional relationship between the light source LG that illuminates the print medium PLb, which is a target of rendering, and the viewpoint VP with respect to a predetermined coordinate x of the print medium PLb is exemplified. FIG. 5 shows a light source direction vector ωl from the coordinate x toward the light source LG, a viewpoint direction vector ωv from the coordinate x toward the viewpoint VP, and a half vector HV of both the light source direction vector and the viewpoint direction vector. A reference numeral Np denotes a normal vector when the print medium PLb is assumed to be a complete plane PLp, and a reference numeral Nb denotes a normal vector at the coordinate x of the actual print medium PLb which is not a complete plane. In FIG. 4, the viewpoint VP (the camera) is assumed to be present substantially in front of the print medium PLb, and a rendering result of the print medium PLb is shown.

In the image processing device 100 according to the embodiment, a position and an angle of the print medium in the virtual space can be freely changed, and an appearance thereof together with the image on the print medium can be checked. When a user operates a pointing device (not shown) on an image displayed on the image display unit 151, the image processing device 100 repeats a series of processing of performing the rendering processing again by the rendering execution unit 121 and displaying a processing result on the image display unit 151. Here, the pointing device may be a 3D mouse, a tracking ball, or the like, or may be a type in which a multi-touch panel provided in the image display unit 151 is operated with a finger or a touch pen. For example, when a multi-touch panel is provided on the surface of the image display unit 151, the print medium PLb or the light source LG may be directly moved with a finger or the like, the print medium PLb may be rotated using two fingers, or a distance between the light source LG and the print medium PLb may be three-dimensionally changed.

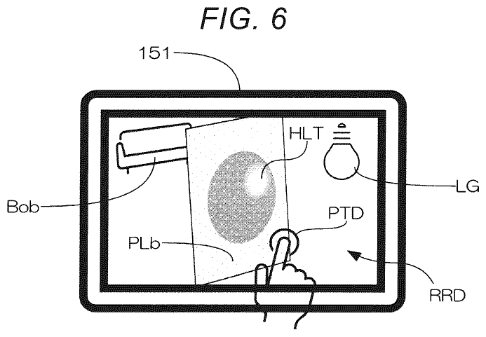

When the positions and angles of the print medium PLb and the light source LG in the virtual space are changed, the rendering execution unit 121 performs the rendering processing each time, and displays the rendering image RRD on the image display unit 151. An example of such display is shown in FIG. 6. As shown in FIG. 6, when the positions, angles, and the like of the print medium PLb and the light source LG in the virtual space are changed, the print medium on which the image is printed is subjected to the physically-based rendering each time, and the actual print medium on which the image is printed is shown in a state close to being viewed in a real space.

An outline of the display of the print medium on which the image data ORG is printed is described above. In the image processing device 100 according to the embodiment, when the CMS 111 performs the color conversion on the image data ORG, an image obtained by rendering a result of the color conversion using the print profile MP is displayed on the image display unit 151.

In the embodiment, in addition to converting a color of the image to be printed on the print medium into a color of the image to be actually printed by the color management system (CMS), and handling the print medium on which the image is printed as a 3D object in the lighting processing during rendering, the texture of the surface of the print medium is considered using the texture parameter TXT of the surface of the print medium, and thus reproducibility of the print medium displayed on the image display unit 151 is high.

Hereinafter, this point will be sequentially described as

[1] a print medium on which an image is printed is handled as a 3D object, and

[2] a texture of a surface of the print medium is considered using the texture parameter TXT.

Regarding [1], how the 3D object appears in the virtual space can be represented using a bidirectional reflectance distribution function (BRDF) and luminance of reflected light at each part of the object. The bidirectional reflectance distribution function BRDF indicates angular distribution characteristics of the reflected light when the light is incident from a certain angle. The luminance is brightness of the object. The bidirectional reflectance distribution function and the luminance are also referred to as the illumination model. An example of the reflection model employed in the embodiment will be described below. The BRDF can be represented as a function f(x,ωl,ωv) and the luminance can be represented as a function L(x,ωv), as the following formulas (1) and (2).

f(x,ωl,ωv)=kD/π+kS*(F*D*V) (1)

L(x,ωv)=f(x,ωl,ωv)*E⊥(x)*n·ωl (2)
x: in-plane coordinates, ωv: viewpoint direction vector, ωl: light source direction vector
kD: diffuse albedo, kS: specular albedo F: Fresnel term, D: normal distribution function, V: geometric attenuation term
E⊥(x): illuminance incident perpendicularly to coordinate x, n: normal vector

The first term of the BRDF, that is, kD/π, is a diffuse reflection component and is a Lambert model. The second term is a specular reflection component and is a Cook-Torrance model. In formula (1), kd/π may be referred to as a diffuse reflection term, and kS*(F*D*V) may be referred to as a specular reflection term. Since models and calculation methods of the Fresnel term F, the normal distribution function D, and the geometric attenuation term V are known, the description thereof will be omitted. As the BRDF, a function according to reflection characteristics of a surface of the 3D object and a purpose of rendering may be used. For example, a Disney principled BRDF may be used. In the embodiment, the BRDF is used as a function representing light reflection. A bidirectional scattering surface reflectance distribution function (BSSRDF) may be used as a function representing the light reflection.

As can be seen from the above formulas (1) and (2), the calculation of the reflection model requires the normal vector n, the light source direction vector ωl, and the viewpoint direction vector coy. The print medium is handled as a 3D object implemented by a plurality of minute polygons as a target of the rendering processing, and the normal vector n reflecting minute unevenness on the surface of the print medium is calculated based on a polygon normal Np and a normal map to be described later. Accordingly, in the vertex pipeline VPL, the polygon normal Np and UV coordinates for determining a reference position of the normal map are calculated and input to the pixel pipeline PPL together with the light source direction vector ωl and the viewpoint direction vector coy. In the pixel pipeline PPL, the pixel shader PS refers to a normal map given as one of the texture parameters by using the UV coordinates, and calculates the normal vector n based on a value of the referred normal map and the polygon normal Np.

In the embodiment, as described above, the print medium on which the image is printed is handled as the 3D object, and the physically-based rendering is performed by the above formulas (1) and (2). As shown in FIG. 6, the light source direction vector ωl and the viewpoint direction vector ωv are calculated each time the user changes the position or the angle of the print medium PLb or the light source LG in the virtual space using the pointing device.

Regarding [2], in the embodiment, the texture parameter TXT is used to consider the texture of the surface of the print medium. The texture parameter TXT may be as follows, and it is not necessary to consider all of the parameters, and at least one of the following parameters, such as smoothness, may be considered.

Smoothness S or Roughness R:

A parameter that indicates smoothness of the surface of the 3D object. The smoothness S is generally designated in a range of values from 0.0 to 1.0. The smoothness S affects the normal distribution function D and the geometric attenuation term V of the BRDF in formula (1) as described above. When the value is large, the specular reflection is strong and a glossy feeling is exhibited. The roughness R may be used instead of the smoothness S. The smoothness S and the roughness R can be converted by S=1.0−R. The smoothness may be referred to as a degree of smoothness, and the roughness may be referred to as a degree of roughness.

Metallicity M:

A parameter that indicates a degree to which the surface of the 3D object is metallic. When the metallicity of the surface is high, a value of the metallicity M increases. When the metallicity M is large, an object surface tends to reflect light from surroundings, resulting in reflection of a surrounding scenery, which tends to hide a color of the object itself. The metallicity M affects the Fresnel term F.

The Fresnel term F can be represented as the following formula (3) using a Schlick approximation.

F(ωl,h)=F₀+(1−F₀)(1−ωl·h)⁵ (3)

Here, h is a half vector of the viewpoint direction vector ωv and the light source direction vector ωl, and F₀ is a specular reflectance at the time of perpendicular incidence. The specular reflectance F₀ may be directly designated as a color of specular reflection light (a specular color), or may be given by formula (4) of linear interpolation (here, referred to as a lerp function) using the metallicity M.

F₀=lerp(0.04,tC,M) (4)

Here, tC is a color of the texture of the 3D object (an albedo color). The value 0.04 in formula (4) is a representative value for each of RGB, which indicates a general value to be non-metallic. The same applies to a texture color tC.

Normal Map:

The normal map represents a parameter that represents normal vectors of minute uneven surfaces on the surface of the print medium. By associating (pasting) the normal map with the 3D object, it is possible to give the 3D object the normal vectors of the minute uneven surfaces on the surface of the print medium. The normal map may affect the Fresnel term F, the normal distribution function D, and the geometric attenuation term V of the BRDF.

Other Texture Parameters:

Examples of the parameters that can function as the texture parameters include a specular color, and a clear coat layer parameter indicating presence or absence of a clear coat layer on the surface of the print medium, a thickness thereof, or a degree of transparency.

As described above,

[1] the print medium on which an image is printed is handled as a 3D object, and

[2] the texture of the surface of the print medium is considered using the texture parameter TXT.

Accordingly, in the image processing device 100 according to the embodiment, the appearance of the print medium on which the image is printed is displayed on the image display unit 151 with a high degree of freedom and high reproducibility. In this case, when the texture parameter is changed, the appearance of the image changes. For example, as shown in FIG. 4, when viewed from the direction facing the print medium, the texture of the surface of the print medium and the roughness caused by the fine unevenness of the surface of the print medium appear. As shown in FIG. 6, when the print medium is rotated and the print medium is viewed from an oblique direction, illumination by the light source LG reflects on the surface of the print medium, and a resultant highlight portion HLT appears. Such a change in display affects the appearance of the print medium on which the image is printed. Illumination light is not limited to illumination directly directed at the print medium, such as spotlight, and also includes sunlight, indirect illumination, and indirect light.

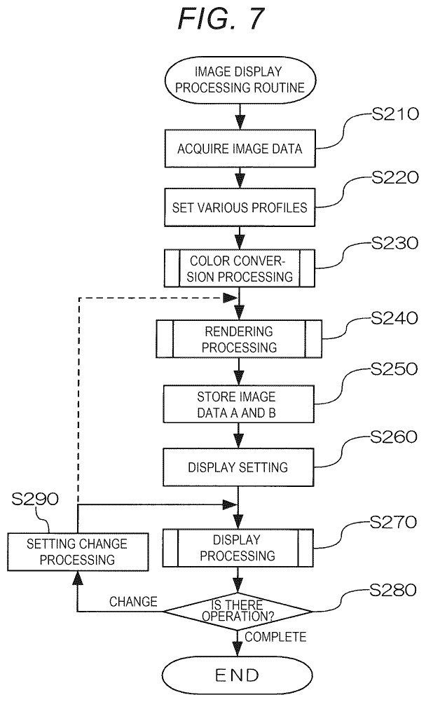

An image display processing routine executed in the image processing device 100 that performs the above processing will be described with reference to a flowchart in FIG. 7. The processing is started when the user compares how an image to be printed appears on a desired print medium. When the illustrated processing is started, first, processing of acquiring the image data ORG as a printing specification is performed (step S210). The image data ORG can be acquired by various methods as described above.

Next, various profiles such as the input profile IP and the common color space profile CP corresponding to the acquired image data ORG are acquired from the profile storage unit 136 (step S220), and the color conversion processing to which the print profile MP is applied is performed (step S230).

Thereafter, the rendering processing is performed (step S240). The rendering processing is performed on the color-converted image data in step S230. At this time, rendering without applying the texture parameter TXT and rendering with the texture parameter TXT applied are performed, and image data A and image data B obtained as a result are stored in the image memory 139 (step S250). Details of the two rendering processing will be described later. After the image data A to which the texture parameter TXT is not applied and the image data B to which the parameter TXT is applied are stored, display setting is performed (step S260). The display setting is for setting a way of displaying the image data A and B, and is performed by the user operation UOP. Thereafter, image display processing according to the user operation UOP is performed (step S270). After the display processing, it is determined whether there is any operation by the user (step S280), and when there is an operation to instruct a change in display, setting change processing is performed (step S290), and then the display processing is performed again. On the other hand, when there is an operation to instruct completion, the processing exits to “END” and the image display processing routine ends.

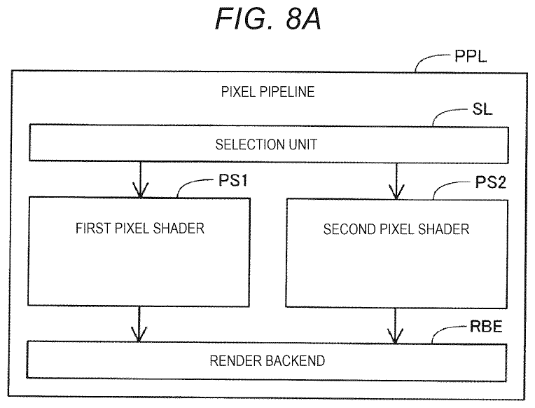

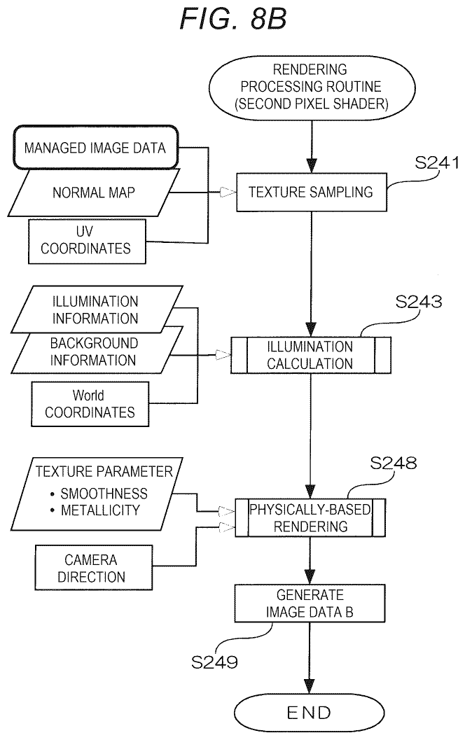

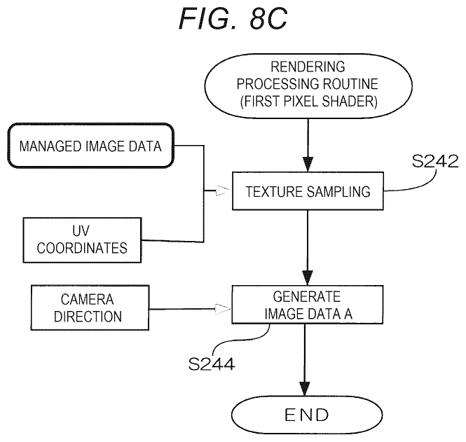

The rendering processing in step S240 described above will be described in detail. In the embodiment, the pixel pipeline PPL includes two pixel shaders PS1 and PS2 as shown in FIG. 8A. The first pixel shader PS1 is implemented to perform the rendering processing to which the texture parameter TXT is not applied, and the second pixel shader PS2 is implemented to perform the rendering processing to which the texture parameter TXT is applied. The processing shown in FIG. 8B is the processing performed by the second pixel shader PS2, and shows a part corresponding to the processing of [2], that is, the texture of the surface of the print medium is considered using the texture parameter TXT, in the rendering processing described above. An internal configuration of the second pixel shader PS2 is optimized such that the processing described below can be performed at a high speed.

The second pixel shader PS2 performs texture sampling processing (processing S241). The processing is a processing of reading, based on the UV coordinates calculated in the vertex pipeline VPL, a color of an image printed on the print medium from the managed image data MGP, and a normal line of the unevenness of the surface of the print medium from the normal map which is one of the texture parameters. When the texture sampling processing is completed, illumination calculation is performed (processing S243). In the illumination calculation, a color, an intensity, and the like of the illumination are calculated using the illumination information LGT and the background information BGD based on World coordinates representing a positional relationship between the light source LG and the print medium.

After the above processing is performed, calculation of physically-based rendering is performed. Since the second pixel shader PS2 performs the calculation when the texture parameters are applied, the second pixel shader PS2 performs the physically-based rendering based on values calculated in the texture sampling processing (processing S241) and the illumination calculation (processing S243) and the texture parameters (here, the smoothness and the metallicity), and calculates a color and an appearance of the image printed on the print medium as the 3D object according to a direction of the viewpoint VP which is a camera direction (processing S248). The normal map, which is one of the texture parameters, is also used, and the unevenness on the surface of the print medium is processed as the texture. A rendering result is generated as the image data B (processing S249).

Next, the processing performed by the first pixel shader PS1, that is, the rendering processing to which the texture parameter TXT is not applied will be described with reference to FIG. 8C. The first pixel shader PS1 performs the texture sampling processing (processing S242). The texture sampling processing S242 corresponds to the processing S241 performed by the second pixel shader PS2, whereas the first pixel shader PS1 does not perform the processing of reading the normal line of the unevenness on the surface of the print medium from the normal map. The first pixel shader PS1 reads a color of the image to be printed on the print medium from the managed image data MGP based on the UV coordinates calculated in the vertex pipeline VPL in the texture sampling processing (processing S242). Then, an appearance of the image printed on the print medium as the 3D object is calculated according to the direction of the viewpoint VP which is the camera direction, and the image data A to which the texture parameter is not applied is generated (processing S244). Therefore, when the rendering processing (step S240) is performed, the image data B representing an image B to which the texture parameter is applied is generated by the second pixel shader PS2, and the image data A representing an image A to which the texture parameter is not applied is generated by the first pixel shader PS1. As will be described later, since the image A and the image B are switched or displayed in parallel for comparison, the positional relationship between the print medium as the 3D object in the virtual space and the camera or the light source as the viewpoint and an angle of the surface of the print medium with respect to the camera or the light source are the same in the calculation processing of both pixel shaders PS.

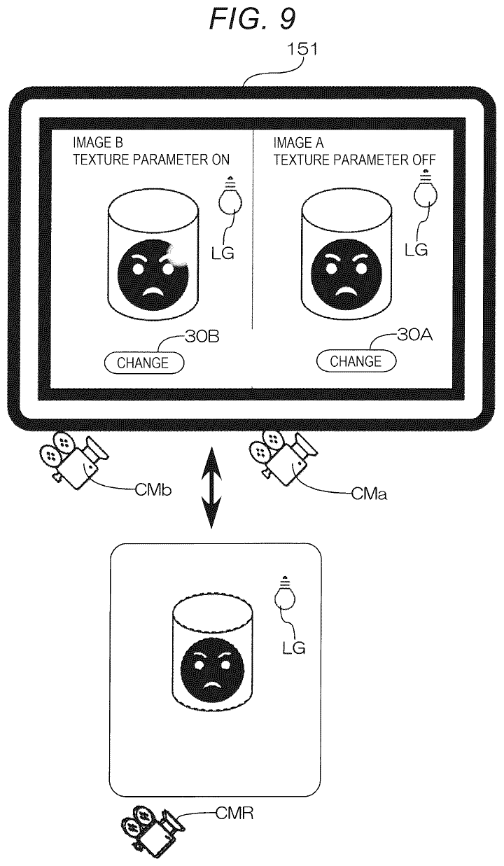

The image data A and B thus generated are displayed on the image display unit 151 (step S270) according to the display setting (step S260) shown in FIG. 7. An example of the display in step S270 is shown in FIG. 9. In the example, the image A subjected to the color conversion and the rendering processing to which the texture parameter TXT is not applied and the image B subjected to the color conversion and the rendering processing to which the texture parameter TXT is applied are displayed side by side on the image display unit 151. The image display unit 151 also displays a light source indicating a position and a direction of the light source LG, a change button 30 for instructing to change the display, a complete button 20 for instructing to complete the display, and the like. In FIG. 9, for convenience of illustration, camera marks CMa and CMb are displayed outside a frame of the image display unit 151, whereas the actual camera marks CMa and CMb are displayed on the image display unit 151. By operating the camera marks CMa and CMb, the direction of the viewpoint in the physically-based rendering can be changed, and the appearance of the images A and B can be changed in synchronization. In the virtual space in which the physically-based rendering is performed, as shown in a lower part of FIG. 9, the positional relationship between the light source LG and the print medium as the 3D object, the positional relationship between the print medium and the viewpoint VP, and the direction of the viewpoint VP are the same. Of course, the camera marks CMa and CMb may be individually operated, and the direction of the viewpoint VP may be individually changed. A case in which the direction of the viewpoint VP is synchronized makes it easier to recognize a difference in appearance between the images A and B due to appropriateness of the texture parameter TXT as compared with a case in which the direction is not synchronized.

When one of change buttons 30A and 30B is operated in a state in which the image A and the image B are displayed on the image display unit 151, the processing of step S290 in FIG. 7 is performed, and the display setting is changed. The change buttons 30A and 30B are buttons for changing the setting of the texture parameter TXT. By operating the change buttons 30A and 30B, processing of changing the images A and B to another image C is performed. Another image C may be, for example, an image obtained by performing the rendering processing on the print medium having different texture parameters TXT in advance, or an image generated by newly setting the texture parameter TXT and performing the rendering processing again. In the former case, since the images A, B, and C to be displayed are already generated, it is sufficient to perform the processing of step S270 after the display setting change processing of step S290, as shown by a solid line in FIG. 7. On the other hand, as in the latter case, when the new texture parameter TXT is designated by the operation of the change button, the processing returns to the rendering processing of step S240 as indicated by a broken line in FIG. 7, and the processing subsequent to the rendering processing to which the newly set texture parameter TXT is applied is performed.

When the image display processing is performed by the image processing device 100 described above, the image B subjected to the rendering processing to which the texture parameter TXT is applied can be observed side by side with the image A in the case in which the texture parameter TXT is not applied. Therefore, by applying the texture parameter TXT, it is possible to easily understand how the print medium on which the image is printed appears. In addition, since the appearance of the image on the print medium in the case in which the texture parameter TXT is not used can be compared, it is possible to understand a meaning of the texture parameter TXT. As a result, when the user finally prints the image data ORG, it is possible to easily grasp the influence on the texture of the print medium and the actual appearance without performing trial printing, to shorten a time until a desired printed matter is obtained, and to prevent a waste of the printed matter.

In the above-described embodiment, two pixel shaders PS are provided, and the pixel shader may be three or more, such as additionally providing a pixel shader for performing the rendering processing under different conditions of the texture parameter TXT. In the embodiment, the first pixel shader PS1 does not perform the illumination processing (processing S243 in FIG. 8B). Alternatively, the first pixel shader PS1 may perform the illumination processing and not perform the rendering processing (processing S245) using the texture parameter TXT. The texture parameters TXT may be set not to be entirely applied, and a part thereof, for example, the normal map, may be set to be applied. Further, in the embodiment, a dedicated pixel shader is prepared depending on whether the texture parameter TXT is applied, and a single pixel shader PS may be caused to sequentially or time-divisionally perform the rendering processing to which the texture parameter TXT is applied and the rendering processing to which the texture parameter TXT is not applied, and results thereof may be stored.

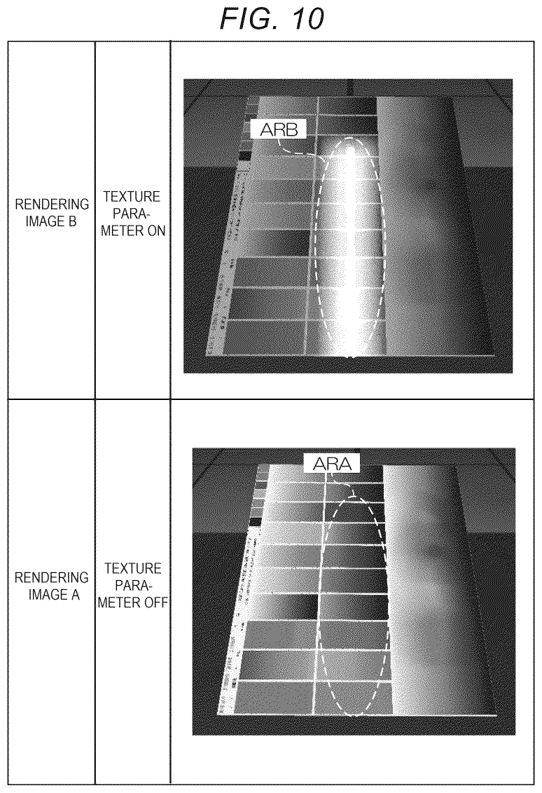

FIG. 10 shows an example of actual rendering images A and B. The rendering image A is an image obtained by performing the rendering processing to which the texture parameter TXT is not applied. The rendering image B is an image obtained by performing the rendering processing to which the texture parameter TXT is applied. In a rendering image to which the texture parameter TXT is applied, a reflection of illumination appears and the unevenness of the print medium is visible in the vicinity of an area ARB. In addition, since the illumination light is dark as a whole, there is a large difference in brightness between a place where there is a reflection and a place where there is no reflection. On the other hand, in the image A rendered by turning off the texture parameter TXT, since the illumination calculation is not performed, no reflection of the light source is visible in the area ARA and no normal map is applied, and thus no unevenness on the surface of the print medium appears. When the illumination calculation is not performed, there is no difference in brightness due to the illumination in the entire print medium.

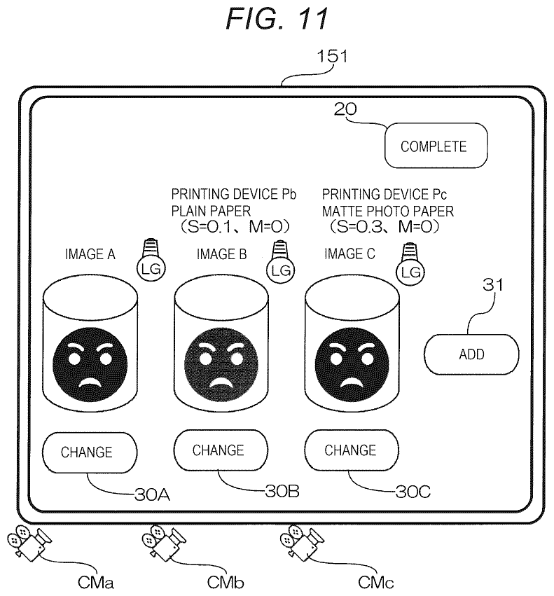

In the above example, the texture parameter TXT is directly designated and used for the rendering processing. Since the texture parameter TXT depends on types of the print medium, for example, plain paper, photo paper, matte-processed paper, glossy paper, plastic sheet, and aluminum vapor deposited paper, the texture parameter TXT may be indirectly set by the print medium. The example is shown in FIG. 11. Depending on the printing device, there exists processing of dispensing a primer to enhance adhesion of ink on the surface of the print medium before dispensing the ink. In this case, the texture parameter TXT may be set according to a combination of the printing device and the print medium.

In FIG. 11, three images of the image A, the image B, and the image C are displayed. The change buttons 30A, 30B, and 30C for changing the texture parameter TXT to change the images are displayed below the images A, B, and C, and a mark indicating the light source LG is displayed at upper right of each image. The complete button 20 is displayed at upper right of a screen of the image display unit 151, and an addition button 31 for adding an image is displayed at a right end of the screen. Camera marks CMa to CMc displayed outside the frame of the image display unit 151 indicate that observation conditions for the print medium are the same, and may be used to change the viewpoint VP as in the example of FIG. 9. In this case, the camera marks CMa to CMc are displayed on the image display unit 151, and regardless of which of the camera marks CMa to CMc is operated, the viewpoint of viewing each image can be changed all at once. Among the three displayed images, the image A is an image obtained by performing the rendering processing to which the texture parameter TXT is not applied, as in FIG. 9. The image B is an image obtained by performing the rendering processing on an assumption that plain paper is used in a printing device Pb. The image C is an image obtained by performing the rendering processing on an assumption that matte-processed photo paper is used in a printing device Pc.

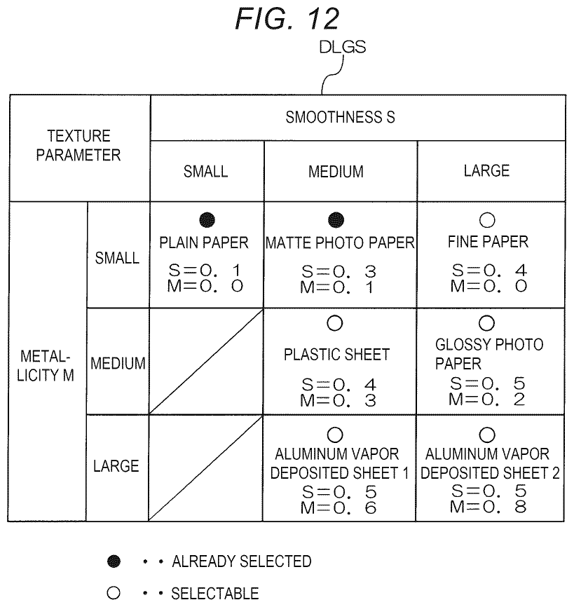

In the example, a total of three images are displayed, and not only comparison between the case in which the texture parameter TXT is not applied and the case in which the texture parameter TXT is applied, but also comparison between a case in which different texture parameters TXT are applied can be easily performed. When the change buttons 30A, 30B, and 30C or the addition button 31 is pressed, a diagonal box DLGS shown in FIG. 12 is displayed, and the texture parameter TXT to be newly applied can be selected. Therefore, it is easy to correct an existing image or add a new image.

In the example shown in FIG. 12, various print mediums are defined as a combination of the smoothness S and the metallicity M among the texture parameters TXT. In the example, the smoothness S and the metallicity M are divided into approximately small, medium, and large sections, and plain paper, matte-processed photo paper, fine paper, plastic sheet, glossy photo paper, aluminum vapor deposited sheet 1, and aluminum vapor deposited sheet 2 are classified. The plain paper has the smoothness S of 0.1 and the metallicity M of 0.0. On the other hand, the matte-processed photo paper has the smoothness S of 0.3 and the metallicity M of 0.0. As shown in FIG. 12, the smoothness S and the metallicity M are set in combination for other types of paper. Therefore, when these print media are selected, the smoothness S and the metallicity M are determined. In the diagonal box DLGS, a filled circle (•) indicates that the print medium is already selected, and a simple circle (∘) indicates that the print medium is not selected.

When any one of the change buttons 30A, 30B, and 30C is clicked in a state in which the images A, B, and C are displayed on the image display unit 151 as shown in FIG. 11, the setting screen shown in FIG. 12 is displayed. When the user selects any one of the print media, processing of changing the values of the texture parameters TXT, here, the smoothness S and the metallicity M is performed (step S290), and the processing is performed again from the rendering processing (step S240). As a result, the image whose change button is clicked is changed to the image subjected to the rendering processing using the texture parameter TXT corresponding to the selected print medium. Therefore, when various types of print medium are designated, it is possible to easily switch how an image to be printed appears, and check a state in which the physically-based rendering is performed in the virtual space. Therefore, even when the trial printing or the like is not performed, the user can visually recognize how a desired image is printed and appears on the type of the print medium that is assumed to be used, so that a waste of resources and man-hours can be prevented.

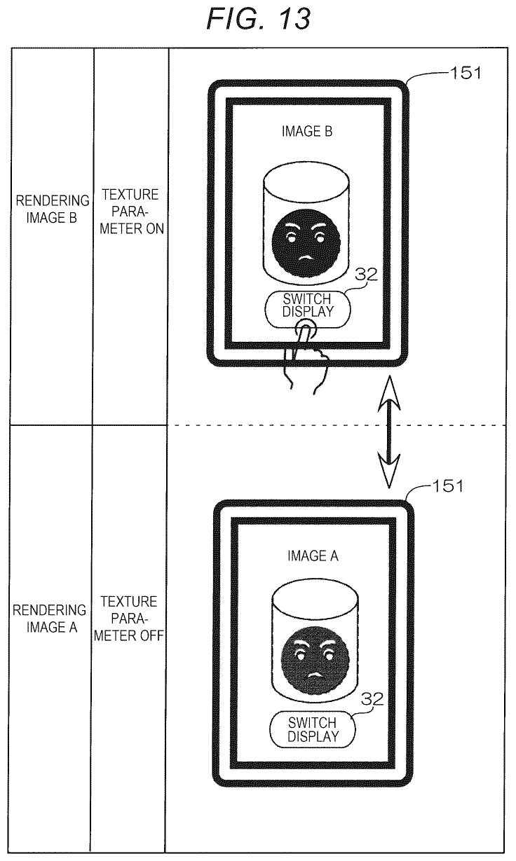

For the appearance of the image when the texture parameter TXT is changed, as shown in FIGS. 9 and 11, the case in which the texture parameter TXT is applied and the case in which the texture parameter TXT is not applied may be in parallel, or the case in which different texture parameters TXT are applied may be in parallel, and as shown in FIG. 13, the images may be displayed in such a manner that the images are switched at the same place. In the example, a display switching button 32 is displayed on the image display unit 151, and each time the display switching button 32 is operated, the image A obtained when the texture parameter TXT is not used and the image B obtained when the texture parameter TXT is used are alternately switched and displayed at the same place. When changing the texture parameter TXT to be applied, a change button may be displayed when the image B to which the texture parameter TXT is applied is displayed, and when the change button is operated, the setting screen shown in FIG. 12 may be displayed. Of course, a screen for selecting a file in which the texture parameter TXT is recorded may be displayed, and the user may directly select the file.

### B. Second Embodiment

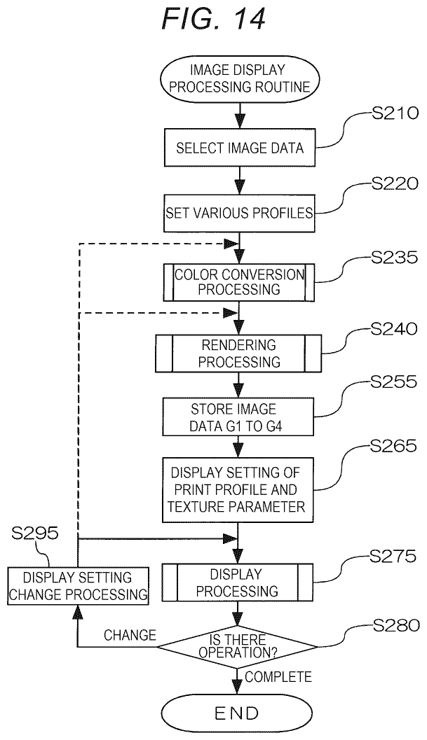

Next, a second embodiment of the image display device 100 will be described. The image display device 100 according to the second embodiment has a hardware configuration same as that of the first embodiment, and an outline of the color conversion processing and the rendering processing is the same. An image display processing routine in the second embodiment is shown in FIG. 14, and the processing corresponds to the processing in the first embodiment. However, the processing of steps S230, S250, S260, S270, and S290 in the first embodiment are steps S235, S255, S265, S275, and S295 in the second embodiment, and contents of the processing are slightly different. In step S235, color conversion that does not use a print profile is added. In steps S255 to S295, the print profile and the texture parameter are changed and a resultant image is displayed.

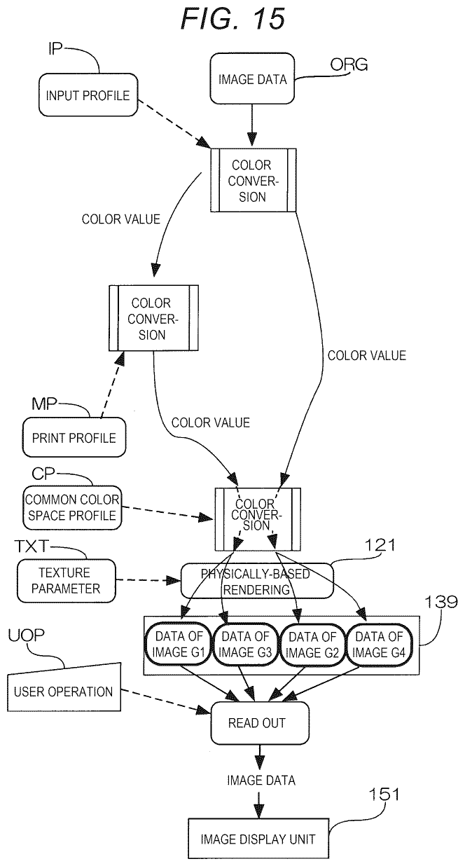

First, the color conversion processing (step S235) according to the embodiment will be described with reference to FIG. 15. As shown in FIG. 15, the image data ORG is converted into a device-independent color value using the input profile IP. The color value is color-converted using the print profile MP, and the obtained color value is subjected to the color conversion using the common color space profile CP. Similarly, image data not subjected to the color conversion using the print profile MP is also subjected to the color conversion using the common color space profile CP, and is subjected to the rendering processing by the rendering execution unit 121. Data of a rendering image is stored in the image memory 139.

The rendering execution unit 121 further performs rendering to which the texture parameter TXT is applied and rendering to which the texture parameter TXT is not applied on each of the image data color-converted using the print profile MP and the image data color-converted without using the print profile MP. As a result, as shown in FIG. 15, data of four images G1 to G4 obtained by combining applications of the texture parameter TXT and the print profile MP are stored in the image memory 139. In the pixel pipeline PPL in the rendering execution unit 121, when only one pixel shader PS is provided, the rendering processing is sequentially performed on the image data of each route, and the result is stored in the image memory 139. When a plurality of pixel shaders PS, for example, four pixel shaders PS are provided, the rendering processing may be performed simultaneously in parallel.

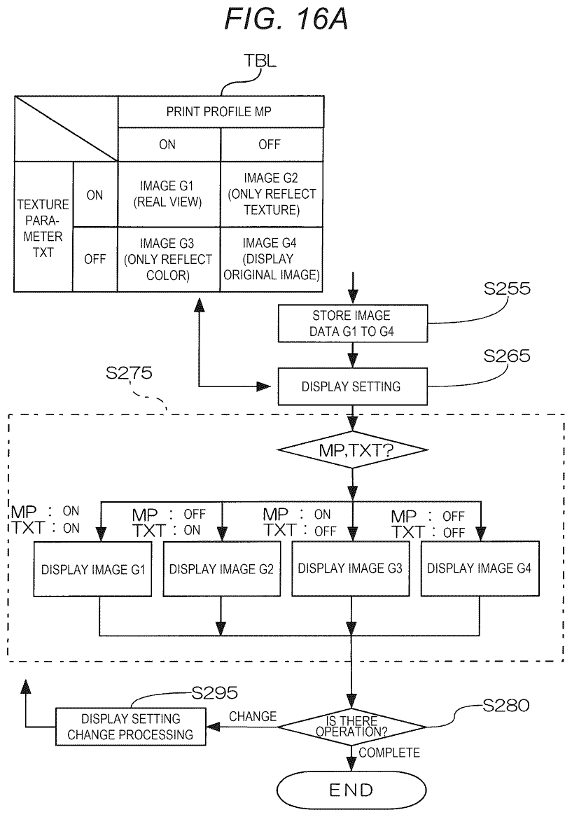

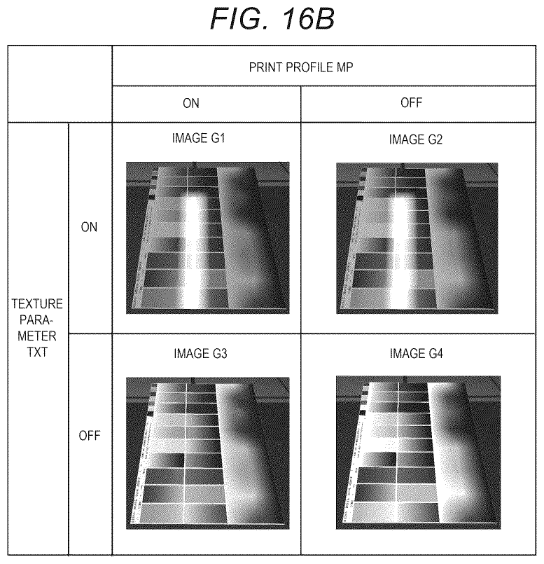

Which of the images G1 to G4 whose data is stored in the image memory 139 is actually displayed on the image display unit 151 is set by the user operation UOP. One or a plurality of pieces of image data are read out and displayed on the image display unit 151 according to the setting by the user operation UOP. Details of image display processing performed by the user operation UOP are shown in FIG. 16A. FIG. 16A shows processing of steps S255 to S295 which are main parts of the processing shown in FIG. 15.

As shown in FIG. 16A, in step S255, four types of images G1 to G4 are stored in the image memory 139. The images G1 to G4 are images obtained when on and off of the application of the print profile MP and on and off of the application of the texture parameter TXT are combined as shown in a table TBL in FIG. 16A. Specifically,
the image G1 is an image obtained when both the print profile MP and the texture parameter TXT are applied, and is referred to as a real view here because it is the closest to an actual print result.
The image G2 is an image obtained when the print profile MP is not applied and the texture parameter TXT is applied, and is an image reflecting only the texture.
The image G3 is an image obtained when the print profile MP is applied and the texture parameter TXT is not applied, and is an image in which a color of an actual image is reproduced by the print profile.
The image G4 is an image obtained when neither the print profile MP nor the texture parameter TXT is applied, and is an original image that does not take into consideration a difference between the printing device and the print medium, the texture of the surface of the print medium, or the like.

When the print profile and the texture parameter are set by the user, the image processing device 100 performs the color conversion processing (step S230) and the physically-based rendering (step S240) by combining on and off of the print profile and on and off of the texture parameter, and stores the four types of images G1 to G4 obtained by combining on and off in the image memory 139. Next, display setting by the user is received (step S265). In the processing, a display setting diagonal box corresponding to the table TBL shown in FIG. 16A is displayed on the image display unit 151, and the user selects a combination of on and off of the print profile MP and on and off of the texture parameter TXT to perform the display setting.

In response to the display setting, processing of displaying any one of the images G1 to G4 on the image display unit 151 is performed (step S275). Specifically, any one of the images G1 to G4 is displayed according to a combination of on and off of the print profile MP and on and off of the texture parameter TXT. The display may display an original image (the image G4) in which the print profile MP and the texture parameter TXT are both off and a real view (the image G1) in which the print profile MP and the texture parameter TXT are both on, as in the display shown in FIG. 9, or may display three or more images, for example, the images G1, G2, and G4, as in the display shown in FIG. 11. At this time, as in FIGS. 9 and 11, the change button and the addition button may be displayed together. As processing of step S295, for example, the change button displayed together with the image G2 may be operated to instruct to change to the image G3 or the addition button may be operated to instruct an addition of the image G3. In response to the change instruction, by performing the display processing of step S275 again, the image G2 is changed to the image G3 or the image G3 is added, and all the images G1 to G4 are displayed. When the display is switched among the images G1 to G4 which are subjected to the color conversion and the physically-based rendering in advance, it is sufficient to perform the processing of step S275 after the display setting change processing of step S295 as shown by a solid line in FIG. 14. On the other hand, when a new print profile is designated by the operation of the change button, the processing returns to the color conversion in step S235 as indicated by a broken line in FIG. 14, or when a new texture parameter is designated, the processing returns to the rendering processing in step S240, and the processing subsequent to each step is performed as in the case of the first embodiment (FIG. 7).

FIG. 16B shows an example of the images displayed on the image display unit 151 by the processing of displaying the image (step S275). As shown in FIG. 16B, the image G1 is an image (a real view) in which the print profile MP and the texture parameter TXT are both on, the image G2 is an image (an image in which only the texture is reflected) in which the print profile MP is off and the texture parameter TXT is on, the image G3 is an image (an image in which only the color is reflected) in which the print profile MP is on and the texture parameter TXT is off, and the image G4 is an image (an image corresponding to the original image) in which the print profile MP and the texture parameter TXT are both off. As shown in FIG. 16B, when the texture parameter TXT is taken into consideration, the appearance of the surface of the print medium covered by the light from the light source is reproduced. When the print profile MP is applied, a difference in color development depending on the print medium is expressed.

According to the second embodiment described above, in addition to the effects same as those of the first embodiment, it is possible to further render the print medium as the 3D object in the virtual space, and to show the appearance of the image on the print medium to the user in various modes in which the print profile and the texture parameters are combined. Therefore, it is possible to understand how the appearance changes not only by applying or not applying the texture parameter TXT, but also by applying or not applying the print profile. As a result, the real view to which both the print profile and the texture parameter are applied can be checked by three-dimensional display in which the real appearance of the image printed on the selected print medium is set in the virtual space. For example, as shown in FIG. 6, when the position or the direction of the print medium in the virtual space is changed or the position or the direction of the light source LG is changed using a pointing device or the like, the physically-based rendering is performed in accordance with the change. Therefore, depending on the position of the light source LG and the texture of the print medium, for example, the smoothness S, it is possible to check a realistic appearance in which the light from the light source LG appears to be covered on the image. Therefore, it is possible to save time and effort to actually print on the print medium.

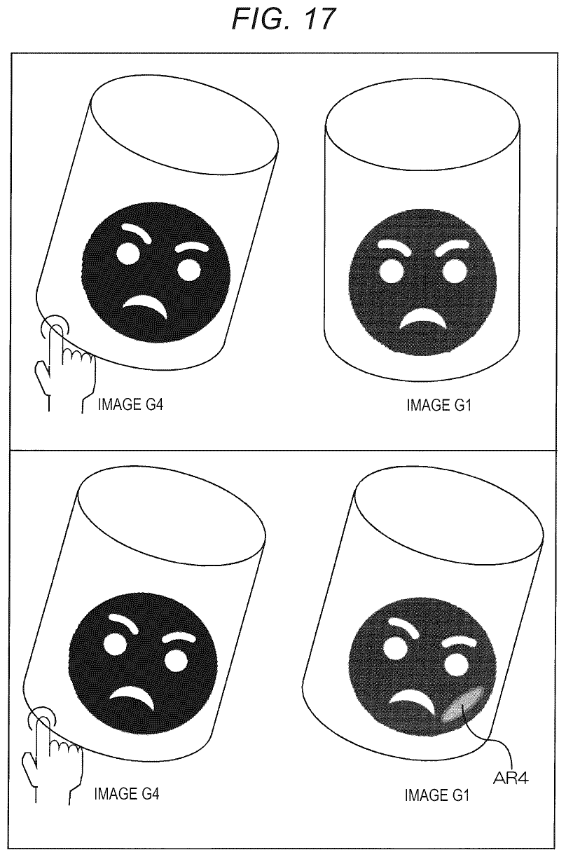

As shown in FIG. 6 in the first embodiment described above, the position and the angle of the print medium displayed on the image display unit 151 can be changed using the pointing device or the like. This is the same in the second embodiment, and when the position or the angle of the print medium is changed, the rendering processing is performed again in accordance with the change, such that the print medium on the image display unit 151 and the appearance of the image printed on the surface thereof are also changed. If a plurality of images are displayed on the image display unit 151 when the position or the angle of the print medium is changed in this manner, a change corresponding to one image may or may not be applied to another image. For example, in the second embodiment, when the image G4 and the image G1 are displayed in parallel, as shown in an upper part of FIG. 17, even when the angle of the print medium corresponding to one image (here, the image G4) is changed, the display of another image (the angle of the print medium) may not be changed. Alternatively, as shown in a lower part, when one angle is changed, the angle of another image may be similarly changed and displayed.

As shown in such display, in particular, as shown in the lower part, when the one print medium is rotated to change the angle, the relationship between the light source LG and the viewpoint VP in the virtual space changes. Therefore, as shown particularly in the second embodiment, in an image generated by applying not only the print profile MP but also the texture parameter TXT, for example, in a print medium having highly smooth surface, the rotation of the print medium may cause reflection of the light source LG. In the example shown in FIG. 17, as a result of rotating the image G4 rendered without applying the texture parameter TXT, the image G1 rendered with applying the texture parameter TXT is also rotated, and an area AR4 in which the light source LG is reflected is visible. Therefore, the user can understand that the appearance of the image G1 formed by the physically-based rendering in consideration of the texture parameter TXT under the light source LG is reproduced with high accuracy, and can check the appearance of the image on the print medium with high accuracy.

In the second embodiment, the appearance of the print medium in the virtual space is determined by combining not only the texture parameter TXT but also the print profile MP. Instead of directly designating the texture parameter TXT, the texture parameter TXT may be designated according to the type of print medium, as shown in FIG. 12 in the first embodiment. For the texture parameter TXT, whether to collectively apply the texture parameters such as the smoothness S, the metallicity M, and the normal map may be set, or whether to apply each parameter one by one may be set. Values of the smoothness S, the metallicity M, and the like may be freely set according to the print medium. In this case, a slide bar or a dial may be displayed for each texture parameter, and the user may set a degree by moving the bar or the dial, or the user may designate a numerical value from 0 to 1.0 for each parameter and designate the numerical value.

### C. Third Embodiment

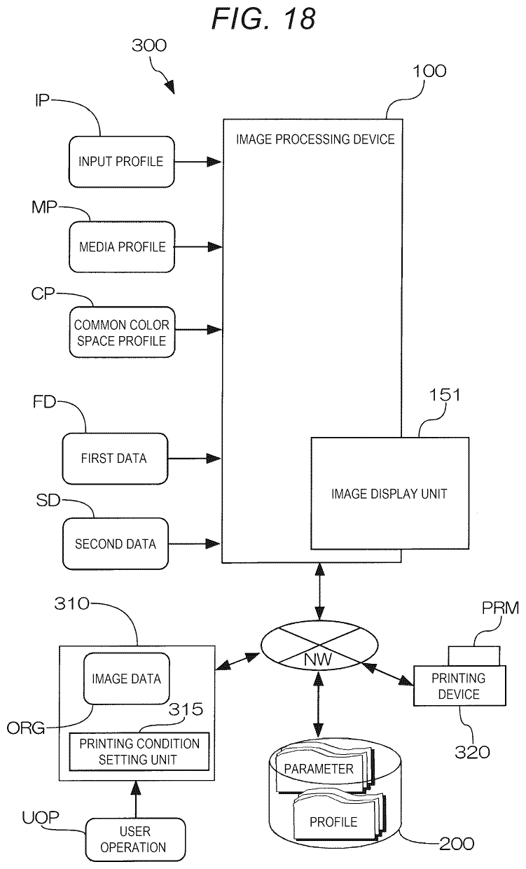

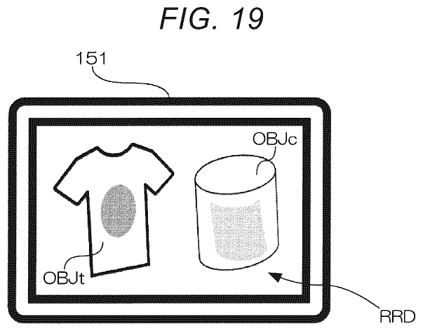

A third embodiment is a printing system 300. As shown in FIG. 18, the printing system 300 includes the image processing device 100, an image preparation device 310, and a printing device 320. In the embodiment, the image preparation device 310 is a computer used by a user, and is a device that prepares the image data ORG which is data of an image expressed in a first color space. The image preparation device 310 may have a function of creating an image, or may simply store the image data and provide the image data to the image processing device 100 as necessary. The image preparation device 310 is coupled via the network NW similarly to the site 200 such that the image processing device 100 can acquire the image data ORG, and the image preparation device 310 may be directly coupled to the image preparation device 100 in a wired or wireless manner.

In the embodiment, the printing device 320 is coupled to the image preparation device 310 via the network NW, receives an instruction from the image preparation device 310, and prints the image data ORG output by the image preparation device 310 on a print medium PRM. Prior to printing by the printing device 320, a user of the printing system 300 acquires the image data ORG by the image processing device 100, and performs the lighting processing using the second data SD including texture parameters while handling the print medium PRM as a 3D object as described in the first embodiment, thereby rendering the print medium PRM including the image data to be printed thereon.

The user checks a rendering result on the image display unit 151, and if necessary, changes a viewpoint, a position of the light source, an intensity of the light source, a white balance, or the like to check the appearance of the print medium PRM, and then outputs the image data ORG from the image preparation device 310 to the printing device 320 via the network NW to print the image data ORG on the print medium PRM. Prior to printing, the user can check the appearance of the image on the print medium PRM through physically-based rendering executed by the image processing device 100. As a result, it is possible to print after checking a difference in texture depending on the type of the print medium PRM, including the smoothness (roughness) of the surface of the print medium PRM. By viewing the rendering result displayed on the image display unit 151, it is also possible to change the color of the image data ORG, change the type of the print medium PRM to be used, change the printing device 320 to be used for printing, or change an ink set thereof in order to obtain a desired print result.

When the image processing device 100 is used together with the printing device 320, a printing condition setting unit 315 that sets a printing condition that affects the appearance of the image on the print medium, which is printed on the print medium by the printing device 320, may be provided in a computer that issues a printing instruction, for example, in the image preparation device 310 in the embodiment. In this way, it is possible to receive, by the user operation UOP, the printing conditions including, for example, selection of a paper tray in which a predetermined print medium is accommodated, selection of an ink set to be used, and selection of a printing device type to be used. Settings received by the printing condition setting unit 315 are transmitted from the image preparation device 310 to the printing device 320, and a profile necessary for color conversion can be set based on the set printing condition, and first and second data to be referred to can be determined based on the printing condition, such that various settings can be easily implemented. In addition to these conditions, the printing condition setting unit 315 may set an observation state of the print medium on which an image is printed in the virtual space, illumination information which is information of illumination on the print medium in the virtual space, object identifying information for identifying a 3D object in the virtual space, background information for identifying a background in the virtual space, and the like.

The print medium to be printed by the printing device 320 may be a medium other than paper. For example, the printing device may be a textile printer that prints on fabric or a printing device that prints on a solid material such as a can or a bottle. In addition to the configuration in which the printing is directly performed on an object, a configuration of a printing device may be employed in which printing is performed on a transfer medium such as a transfer sheet and ink formed on the transfer medium is transferred to fabric or a solid material which is a print medium. As such a transfer type printing device, there is a dye-sublimation type printing device. In such a transfer type configuration, the print medium is a transferred final printed matter. In such a case, texture parameters and the like related to a structure and a texture of a surface of fabric, metal, glass, plastic, or the like, which is a print medium, may be prepared in accordance with properties of the print medium, and the physically-based rendering may be performed in the image processing device 100. Also in the transfer type printing device, the texture parameter represents not the transfer medium but the texture of the final printed matter. FIG. 19 shows a display example on the image display unit 151 in the case of printing on the fabric or the can. In FIG. 19, for the sake of understanding, an object OBJt printed on a T-shirt and an object OBJc printed on the can are shown together, whereas, normally, one print medium is displayed at a time. Of course, a plurality of rendering execution units may be prepared, and a plurality of results of the physically-based rendering may be simultaneously displayed.

### D. Other Embodiments

(1) The disclosure can also be implemented in the following aspects. One aspect thereof is an image processing device that generates a rendering image of a print medium on which an image is printed. The image processing device includes: an image data acquisition unit that acquires image data which is data of an input image expressed in a first color space; a color conversion unit that performs color conversion of converting, using a color conversion profile prepared in advance, the image data into an expression in a second color space to be used during rendering, and generates converted image data; an application setting unit that performs a setting related to an application to physically-based rendering on at least one parameter related to an appearance of the print medium among parameters to be used when performing the physically-based rendering on the print medium as a 3D object; a rendering execution unit that performs the physically-based rendering of a printed print medium on which the input image is printed using the converted image data and the parameter set for the application, and generates a rendering image corresponding to an appearance of the print medium on which the converted image data is printed in a virtual space; and a display unit that displays the rendering image in a mode in which a difference in applications of the parameters is comparable. In this way, the image processing device displays appropriateness of the parameters and the difference in setting related to the appearance when the image is printed in a comparable manner, and thus the user can easily grasp a relationship between the appearance when the image is printed and the parameters in the physically-based rendering without performing trial printing one by one. Therefore, a result of the image processing performed by the image processing device can be referred to for obtaining a desired print result.

Since the image processing device performs the color conversion and the physically-based rendering, it is possible to accurately reproduce how the printed print medium appears based on the image data. For example, how the print medium appears can be freely calculated by various factors such as a position and an angle of a light source when the print medium is viewed, an angle of the surface of the print medium with respect to a line-of-sight, and a texture of the surface of the print medium itself such as gloss. Instead of preparing a state of the image to be printed on the print medium according to conditions, the appearance is displayed by the physically-based rendering, and thus there is no problem of lack in flexibility due to enormous combinations when the number of conditions increases. It is also possible to reproduce the texture of the print medium. That is, in such an image processing device, the print medium is handled as a 3D object in the virtual space, and the print data is calculated as a printed object on the print medium, and thus it is possible to determine the appearance of the image on the print medium from various viewpoints and various angles. Accordingly, it is easy to employ a configuration for correcting a color tone and an arrangement of the image data. When the rendering image is shown in consideration of the characteristics of the print medium, the influence of illumination, and the like, it is possible to prevent occurrence of inconsistency between an image to be printed and an impression of the image printed on the print medium, it is also possible to reduce work of repeating trials and errors by adjusting an original image and a printing condition, and it is also possible to reduce cost and time required for printing trials.

Such an image processing device may be implemented as a device that performs only the above-described image processing, or may be implemented as a device including a function of storing an image to be printed. Alternatively, a device including a function of creating an image to be printed or a device for printing an image may be implemented. The image processing device may be implemented by a computer including a GPU, or may be implemented as a distributed system in which necessary functions are installed in a plurality of sites and can be linked. When the image processing device is implemented as a distributed system, a processing load of a terminal is reduced, and thus it is easy to execute the above-described image processing even in a mobile terminal such as a tablet, and convenience for the user is further improved.

Such a rendering execution unit can employ various existing configurations. In general, rendering may be performed by being divided into a plurality of elements such as viewpoint conversion in which three-dimensional world coordinates are converted into a coordinate system viewed from a viewpoint, culling in which vertices unnecessary for the rendering are excluded from a 3D object, clipping in which invisible coordinates are excluded, and rasterization. The processing may be a configuration suitable for processing in a dedicated GPU, and may be implemented by a pipeline configuration including a vertex pipeline that performs processing related to vertices of a 3D object and a pixel pipeline that performs processing for each rasterized pixel.

(2) In such a configuration, the parameter may include at least one of an illumination condition under which the print medium is illuminated in the virtual space, an observation condition under which the print medium is observed, and a texture condition related to a texture of the print medium. In this way, it is possible to easily compare the appearance when various conditions are changed. The conditions may be changed independently or in combination. The texture conditions include smoothness (or roughness) of the surface of the print medium, metallicity, a normal map, a specular color, and a clear coat layer parameter. The conditions may be compared simply as on and off. Alternatively, for example, different degrees of smoothness may be compared. The comparison is not necessarily limited to two conditions, and the comparison may be performed under three or more conditions. In addition, the comparison may be performed under a condition in which two or more parameters are combined.

(3) In the configuration of (1) or (2) as described above, the display unit may switch and display rendering images with different settings of the parameters related to the application. In this way, a difference in appearance can be observed in a so-called isolated manner. Further, in the case of displaying by switching, it is not necessary to handle a plurality of rendering images at the same time, and the processing may be simplified.

(4) In the configuration of (1) or (2) as described above, the display unit may display in parallel a plurality of rendering images with different settings of the parameters related to the application. In this way, the plurality of rendering images can be simultaneously observed, and the difference in appearance can be observed in a so-called contrast manner. In addition, to view the plurality of rendering images does not require time and effort for switching the images.

(5) In the configurations of (1) to (4) as described above, the rendering execution unit may use a same value or setting for a parameter for which the setting related to the application is not performed among the parameters when generating a plurality of rendering images. In this way, it is not necessary to perform the setting for each of the unchanged parameters. In addition, in the comparison, it is possible to save time and effort for checking whether the setting is different for the parameter for which the setting related to the application is not made. It is not always necessary to use the same value or setting for the parameter for which the setting related to the application is not performed. When the same value or the same setting is not set, if the user can check the value or the setting of the parameter, the user can recognize the influence or change the value or the setting to the value or the setting same as others.

(6) In the configurations (1) to (5) as described above, when a display mode is changed for one of the plurality of rendering images, the display unit may change display of another rendering image to the changed display mode. In this way, it is possible to match the display modes of the plurality of rendering images, and to easily compare the appearances. Of course, when the display mode is changed for one of the plurality of rendering images, all or a part of other rendering images may not be changed to the changed display mode.

(7) In the configurations (1) to (6) as described above, the display unit may display information of the applied setting when displaying the rendering image. In this way, the user can easily understand what the applied setting is. The user can easily understand what settings are applied to perform the rendering processing on the rendering image to be displayed and what values are applied to the rendering image. The information of the applied setting may be always displayed in the vicinity of the rendering image by the display unit, or may be popped up and displayed when the image is clicked by a pointing device or when a cursor is superimposed on the image.

(8) In the configurations (1) to (7) as described above, the rendering execution unit may include a first shader and a second shader, the first shader may perform the physically-based rendering corresponding to a first setting related to the application of the parameter, and the second shader may perform the physically-based rendering corresponding to a second setting different from the first setting. In this case, when one of the shaders is implemented as being used when the texture parameters are not applied, calculation of BRDF or the like can be prevented from being performed in the shader, and the rendering processing can be performed at a high speed. Similarly, it is also effective to provide a shader dedicated to calculation for a specific texture parameter. For example, on an assumption that the smoothness among the texture parameters is higher than a predetermined value, one of the first and second shaders may be implemented as not including parameters of a normal map and a height map and steps of processing the parameters. When a dedicated shader is designated in a case in which the smoothness is designated as a high value, a processing speed can be increased. The first and second shaders are implemented by programs having different processing contents in a dedicated chip such as a GPU. In this case, the first and second shaders are implemented by performing parallel processing on pixels, or a large number of processing units in the GPU in which a first shader program and a second shader program are reflected. Of course, a configuration may be employed in which a first shader circuit as hardware functioning as the first shader and a similar second shader circuit are prepared. Three or more shaders may be provided.

(9) The configurations (1) to (8) as described above may further include: a print profile acquisition unit that acquires a print profile including a parameter related to color development when the input image is printed; an appropriateness setting unit that sets whether to apply the print profile when the image data is converted into the expression in the second color space that expresses an appearance on a print medium using a color conversion profile prepared in advance; and a color conversion unit that performs color conversion according to a setting of the appropriateness of the print profile to generate converted image data. The color conversion unit may set converted image data to which the print profile is applied and converted image data to which the print profile is not applied as a target of the physically-based rendering executed by the rendering execution unit according to setting of the appropriateness setting unit. In this way, it is easy to compare a rendering image corresponding to a converted image to which the print profile is applied with a rendering image corresponding to a converted image to which the print profile is not applied. The appropriateness setting unit may not only set the appropriateness of one print profile, but also prepare a plurality of types of print profiles and set which of the print profiles is to be applied.

(10) In the configuration as described above, the display unit may display a rendering image corresponding to a converted image to which the print profile is applied, in addition to or in parallel with a rendering image corresponding to a converted image to which the print profile is not applied. In this way, it is easier to compare the rendering images which are different in whether the print profile is applied. At this time, two images may be displayed in parallel from the beginning. Alternatively, one image may be first displayed, and in response to an additional instruction, the other image may be added, and both images may be displayed. Both images do not necessarily need to be displayed in parallel, and may be simply displayed by switching. In this way, a display space can be saved.

(11) Another configuration of the disclosure is a configuration as a printing system. The printing system may include: an image data preparation device that prepares image data that is data of an input image expressed in a first color space; the image processing device according to any one of (1) to (10) described above that acquires image data prepared by the image data preparation device and performs image processing; and a printing device that prints the image data. In this way, when the printing is performed by the printing device, the appearance of the print medium on which the image is printed is displayed on the display unit prior to printing, and thus the printing can be performed after checking the appearance. Therefore, it is possible to prevent occurrence of inconsistency between an image to be printed and an impression of the image printed on the print medium, and it is possible to reduce the number of trials and errors repeated by adjusting the original image and the printing condition, and it is also possible to reduce cost and time required for printing trials.

(12) Another configuration of the disclosure is a non-transitory computer-readable storage medium storing an image processing program of generating a rendering image of a print medium on which an image is printed. A non-transitory computer-readable storage medium storing an image processing program, the image processing program causing a computer to execute: a first function of acquiring image data which is data of an input image expressed in a first color space; a second function of performing color conversion of converting, using a color conversion profile prepared in advance, the image data into an expression in a second color space to be used during rendering, and generating converted image data; a third function of performing a setting related to an application to physically-based rendering on at least one parameter among parameters to be used when performing the physically-based rendering on the print medium as a 3D object; a fourth function of performing the physically-based rendering of a printed print medium on which the input image is printed using the converted image data and the parameter set for the application, and generating a rendering image corresponding to an appearance of the print medium on which the converted image data is printed in a virtual space; and a fifth function of displaying the rendering image in a mode in which a difference in applications of the parameters is comparable. In this way, the image processing device in (1) described above can be easily implemented in a device including a computer. Such an image processing program may be recorded on any storage medium such as a magnetic storage medium and read by a computer, or may be downloaded from an external site or the like via a network and executed by a computer.

(13) In each of the above embodiments, a part of the configuration implemented by hardware may be replaced with software. Alternatively, at least a part of the configuration implemented by software may be implemented by hardware, for example, a discrete circuit configuration. When a part or all of the functions in the disclosure are implemented by software, the software (computer program) can be provided in a form stored in a computer-readable storage medium. The “computer-readable storage medium” is not limited to a portable storage medium such as a flexible disk or a CD-ROM, and includes an internal storage device in a computer such as various RAMS or ROMs, and an external storage device fixed to a computer such as a hard disk. That is, the “computer-readable storage medium” has a broad meaning including any storage medium in which a data packet can be fixed instead of being temporarily stored.

The disclosure is not limited to the embodiments described above, and may be implemented by various configurations without departing from the gist of the disclosure. For example, in order to solve a part or all of problems described above, or to achieve a part or all of effects described above, technical characteristics in the embodiment corresponding to the technical characteristics in each embodiment described in the summary of the disclosure can be replaced or combined as appropriate. Technical features can be deleted as appropriate unless described as essential in the present specification.

What is claimed is:

1. An image processing device that generates a rendering image of a print medium on which an image is printed, the image processing device comprising:
an image data acquisition unit configured to acquire image data which is data of an input image expressed in a first color space;
a color conversion unit configured to perform color conversion of converting, using a color conversion profile prepared in advance, the image data into an expression in a second color space to be used during rendering, and to generate converted image data;
an application setting unit configured to perform a setting related to an application to physically-based rendering on at least one parameter related to an appearance of the print medium among parameters to be used when performing the physically-based rendering on the print medium as a 3D object;
a rendering execution unit configured to perform the physically-based rendering of a printed print medium on which the input image is printed using the converted image data and the parameter set for the application, and to generate a rendering image corresponding to an appearance of the print medium on which the converted image data is printed in a virtual space; and
a display unit configured to display the rendering image in a mode in which a difference in applications of the parameters is comparable.

2. The image processing device according to claim 1, wherein
the parameter includes at least one of an illumination condition under which the print medium is illuminated in the virtual space, an observation condition under which the print medium is observed, and a texture condition related to a texture of the print medium.

3. The image processing device according to claim 1, wherein
the display unit is configured to switch and display rendering images with different settings of the parameters related to the application.

4. The image processing device according to claim 1, wherein
the display unit is configured to display in parallel a plurality of rendering images with different settings of the parameters related to the application.

5. The image processing device according to claim 4, wherein
the rendering execution unit is configured to use a same parameter for a parameter for which the setting related to the application is not performed among the parameters when generating the plurality of rendering images.

6. The image processing device according to claim 4, wherein
the display unit is configured to, when a display mode is changed for one of the plurality of rendering images, change display of another rendering image to the changed display mode.

7. The image processing device according to claim 1, wherein
the display unit is configured to display information of the applied setting when displaying the rendering image.

8. The image processing device according to claim 1, wherein
the rendering execution unit includes a first shader and a second shader, the first shader is configured to perform the physically-based rendering corresponding to a first setting related to the application of the parameter, and the second shader is configured to perform the physically-based rendering corresponding to a second setting different from the first setting.

9. The image processing device according to claim 1, further comprising:
a print profile acquisition unit configured to acquire a print profile including a parameter related to color development when the input image is printed;
an appropriateness setting unit configured to set whether to apply the print profile when the image data is converted into the expression in the second color space that expresses an appearance on a print medium using a color conversion profile prepared in advance; and
a color conversion unit configured to perform color conversion according to a setting of the appropriateness of the print profile to generate converted image data, wherein
the color conversion unit is configured to set converted image data to which the print profile is applied and converted image data to which the print profile is not applied as a target of the physically-based rendering executed by the rendering execution unit according to setting of the appropriateness setting unit.

10. The image processing device according to claim 9, wherein
the display unit is configured to display a rendering image corresponding to a converted image to which the print profile is applied and a rendering image corresponding to a converted image to which the print profile is not applied, separately or in parallel.

11. A printing system comprising:
an image data preparation device configured to prepare image data that is data of an input image expressed in a first color space;
the image processing device according to claim 1 configured to acquire image data prepared by the image data preparation device and perform image processing; and
a printing device configured to print the image data.

12. A non-transitory computer-readable storage medium storing an image processing program of generating a rendering image of a print medium on which an image is printed, the image processing program causing a computer to execute:
a first function of acquiring image data which is data of an input image expressed in a first color space;
a second function of performing color conversion of converting, using a color conversion profile prepared in advance, the image data into an expression in a second color space to be used during rendering, and generating converted image data;
a third function of performing a setting related to an application to physically-based rendering on at least one parameter among parameters to be used when performing the physically-based rendering on the print medium as a 3D object;
a fourth function of performing the physically-based rendering of a printed print medium on which the input image is printed using the converted image data and the parameter set for the application, and generating a rendering image corresponding to an appearance of the print medium on which the converted image data is printed in a virtual space; and
a fifth function of displaying the rendering image in a mode in which a difference in applications of the parameters is comparable.
